(19) United States
(12) Patent Application Publication
(10) Pub. No.: US 2025/0119823 A1
(43) Pub. Date: Apr. 10, 2025

(54) AD-HOC TRACKER NETWORK

(71) Applicant: QUALCOMM Incorporated, San Diego, CA (US)

(72) Inventors: Soumen CHAKRABORTY, Bangalore (IN); Sandip HOMCHAUDHURI, San Jose, CA (US); Alireza RAISSINIA, Monte Sereno, CA (US)

(21) Appl. No.: 18/480,846

(22) Filed: Oct. 4, 2023

(51) Int. Cl. H04W 48/18; H04W 48/16; H04W 52/02

(52) U.S. Cl. CPC H04W 48/18; H04W 48/16; H04W 52/0235

(57) ABSTRACT

This disclosure provides methods, components, devices and systems that may help enhance various applications that utilize ad-hoc network clusters, such as position/location tracking.

### TECHNICAL FIELD

This disclosure relates generally to wireless communication, and more specifically, to aspects related to discovery and maintenance of network clusters used for location tracking.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some scenarios, however, devices may communicate directly with each other, using peer-to-peer (P2P) protocols or other such technologies. In such cases, there may be no notion of a BSS and peer devices may communicate between themselves without the need for assistance from an AP.

For example, Wi-Fi Aware capable devices may discover and connect directly to each other without assistance. Wi-Fi Aware is also known as Neighbor Awareness Networking (NAN). NANs work by forming clusters of neighboring devices, with devices joining existing clusters of creating new clusters.

### SUMMARY

The systems, methods and devices of this disclosure each have several innovative aspects, no single one of which is solely responsible for the desirable attributes disclosed herein.

One aspect provides a method for wireless communications, related to discovery and maintenance of network clusters used for location tracking. The method generally includes selecting, based on a use case involving a network cluster, one or more parameters related to discovery or maintenance of the network cluster, and participating in at least one of discovery of the network cluster or maintenance of the network cluster, in accordance with the selected parameters.

In some examples, the use case involves tracking a location of one or more wireless nodes in the network cluster.

In some examples, the one or more parameters comprise a duration of intervals between adjacent discovery windows (DWs), and the participating involves outputting, for transmission, one or more synchronization beacons in DWs separated by the intervals.

In some examples, the method further includes outputting, for transmission, a first frame indicating a capability of the first wireless node to aggregate data from one or more other wireless nodes of the network cluster and share aggregated data via a wireless wide area network (WWAN).

One aspect provides a method for wireless communications, related to discovery and maintenance of network clusters used for location tracking. The method generally includes participating in formation of a network cluster, obtaining location information for one or more other wireless nodes, based on relative location measurements for at least some of the other wireless nodes, and outputting, for transmission via a wireless wide area network (WWAN), a report based on the location information.

In some examples, the method participating in formation of a network cluster comprises outputting, for transmission, synchronization beacons with limited transmit power.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

The appended figures depict certain features of the various aspects described herein and are not to be considered limiting of the scope of this disclosure.

FIG. 1 shows a pictorial diagram of an example wireless communication network.

FIG. 2 shows a pictorial diagram of an example neighbor aware network (NAN), in which aspects of the present disclosure may be utilized.

FIGS. 3 and 4 show example tracking scenarios, in which aspects of the present disclosure may be utilized.

FIGS. 5 and 6 show example neighbor aware network (NAN) scenarios, in which aspects of the present disclosure may be utilized.

FIGS. 7-9 show example timing diagrams related to aspects of the present disclosure.

FIGS. 10A and 10B compare power consumption of different techniques for network cluster discovery and maintenance.

FIGS. 11-14 show example timing diagrams related to aspects of the present disclosure.

FIGS. 15A and 15B compare power consumption of different techniques for network cluster discovery and maintenance.

FIGS. 16A and 16B compare different discovery listening modes.

FIGS. 17-18 show example timing diagrams related to aspects of the present disclosure.

FIG. 19 illustrates example data aggregation level determination related to aspects of the present disclosure.

FIGS. 20A and 20B show examples of cluster formation related to aspects of the present disclosure.

FIG. 21 shows an example of positioning related to aspects of the present disclosure.

FIG. 22 shows a flowchart illustrating an example process performable or at a wireless station that supports ad-hoc network formation related to aspects of the present disclosure.

FIG. 23 shows a flowchart illustrating an example process performable or at a wireless station that supports data aggregation related to aspects of the present disclosure.

FIG. 24 shows a flowchart illustrating an example process performable or at a wireless station that supports positioning related to aspects of the present disclosure.

FIG. 25 shows a block diagram of an example wireless communication device that supports aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless communication and more particularly to techniques that may help enhance discovery and maintenance of network clusters used for various applications, such as position and location tracking.

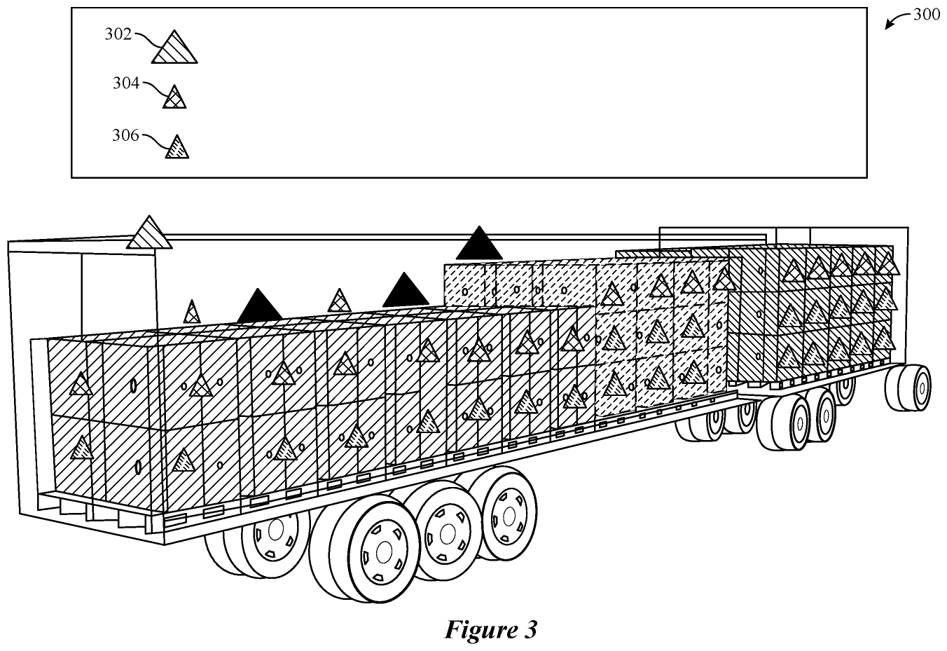

In certain use cases, devices in a network cluster may be better suited for certain roles than other devices. One such use case is for device tracking of items in a shipment, as depicted in FIG. 3, where shipments have IoT devices to track a shipment's route. Tracking scenarios present various challenges.

For example, among a group of tracking devices located close to each other, different devices may be better suited to provide certain functionality. Referring to FIG. 3, some devices (anchor masters 310) may be positioned within a vessel (e.g., a truck, cargo ship, or rail car) such that they have cellular (wide area network-WAN) coverage. Other devices may not have WAN capability (e.g., anchor masters 320 used to provide in-route communication), while other devices (e.g., non-masters 330) may be buried underneath a load with no WAN coverage. Some devices may have global navigation satellite systems (GNSS) coverage for positioning, while some others do not.

In typical tracking scenarios, there are no WLAN access points (APs) nearby with data links to the internet (cloud). However, devices without cellular (GNSS/WAN) coverage may have still have sensor/positioning data to be uploaded to cloud and all devices may have stringent battery life targets.

Aspects of the present disclosure, however, provide a framework using WLAN signaling to form an ad-hoc network cluster that allows devices to collaborate in a manner designed to ensure data connectivity for all devices. The signaling mechanisms provided herein may also improve positioning accuracy and battery life of the devices in the cluster. In some cases, an ad-hoc cluster may be formed and managed in a manner designed to optimize power consumption.

Particular aspects of the subject matter described in this disclosure can be implemented to realize one or more of the following potential advantages. In some examples, the described techniques can be used to efficiently form and maintain ad-hoc network clusters in a power optimal way. The techniques allow for collaboration among devices in the cluster which may be used to achieve efficient and accurate positioning measurements.

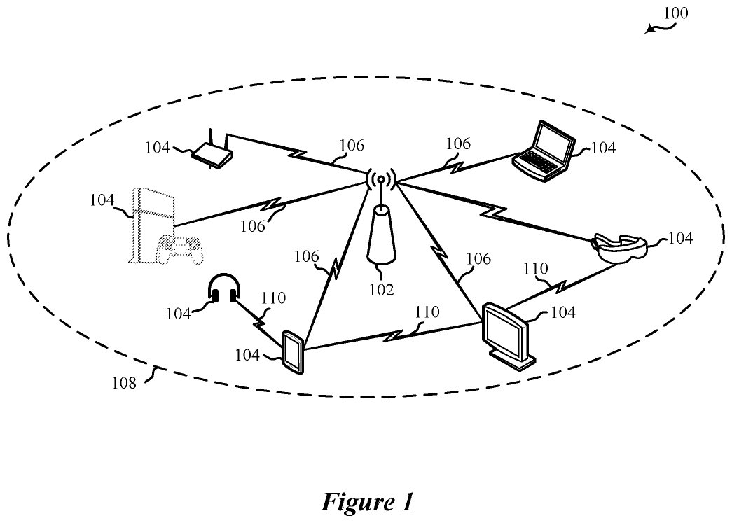

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad-hoc network (or wireless ad-hoc network). Ad-hoc networks may alternatively be referred to as mesh networks or peer-to-peer (P2P) networks. In some cases, ad-hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad-hoc system, one or more of the STAs 104 may assume the role filled by the AP 102 in a BSS. Such a STA 104 may be referred to as a group owner (GO) and may coordinate transmissions within the ad-hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

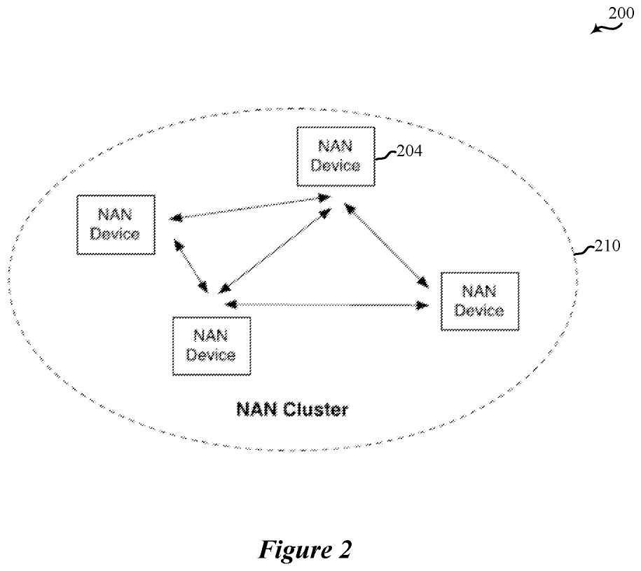

FIG. 2 shows a pictorial diagram of an example neighbor aware network (NAN) 200, in which aspects of the present disclosure may be utilized.

A NAN Network comprises all NAN Devices 204 that share a common set of NAN parameters. These parameters may include, for example, the time period between consecutive Discovery Windows, the time duration of the Discovery Windows, the beacon interval, and NAN Discovery Channel(s). A NAN Cluster 210 generally refers to a collection of NAN devices that share a common set of NAN parameters and are synchronized to a same Discovery Window schedule. A NAN Cluster may be identified by a NAN Cluster ID.

A NAN Device may send multicast NAN Service Discovery frames directly to other NAN devices within range in the same NAN Cluster during the Discovery Window. A NAN Device may send unicast NAN Service Discovery frames directly to any other NAN Device within range in the same NAN Cluster during the Discovery Window

NAN Devices that are part of the same NAN Cluster may participate in a NAN Master Selection procedure. NAN Master Selection is performed on a NAN Cluster basis. Depending on changes in the NAN Cluster, such as NAN Devices that are part of NAN Cluster and their Master Ranks, different NAN Devices may be elected to become NAN Devices in Master role at different times. NAN Devices with equal Master Preference may have equal chance of becoming a NAN Master. In a NAN deployment, NAN devices may serve in different roles, such as a NAN publisher and NAN subscriber. In general, a NAN device serving as a NAN publisher is responsible for sending data by forming a cluster with nearby devices or creating a new cluster, while a NAN device serving as a NAN subscriber receives a notification and can accept service (join a cluster), if interested.

### Aspects Related to NAN Tracker Network

Various aspects relate generally to wireless communication and more particularly to techniques that may help discovery and maintenance of network clusters that may be optimized for location tracking.

Aspects of the present disclosure may be used to form and maintain ad-hoc networks (network clusters) for tracking the position (location) of devices. For example, the techniques proposed herein may be used to form network clusters (e.g., via WLAN connections) with at least one member devices that has a wireless wide area network (WWAN or wireless WAN) that may be used to share location information for multiple members of network cluster.

The techniques may be used in various applications and scenarios, such as shipping containers, trucks, or other vehicles/vessels, with cargo in different containers. As illustrated in example scenario 300 of FIG. 3, each container may have a tracker with a WLAN interface and/or WWAN/WAN interface.

As noted above, tracking scenarios present various challenges. For example, during a shipping route, the relative location of various boxes may be subject to change at every port of transfer. Tracking devices for some containers may also change WAN visibility, while others will mutually relocate into a different cluster formation. Tracking software (e.g., cloud-based) may want to report shipment status to a central office (and to customers) in real-time, with possible event reporting at precise location, all with ultra-low power consumption of tracking devices (trackers).

Typical data transfer needs for sensor data and/or location measurements are relatively sparse (e.g., a few hundred bytes per report). Reporting periodicity may be relatively sparse (e.g., with a periodicity of 15 minutes to 1 hour) and event based measurements (with no periodicity) may also be reported. Reports typically need a time stamp and location stamp. Latency tolerance for measurement reporting may vary. For many applications, reporting to the cloud may be relatively latency-tolerant and asynchronous data can often wait until reporting is synchronized.

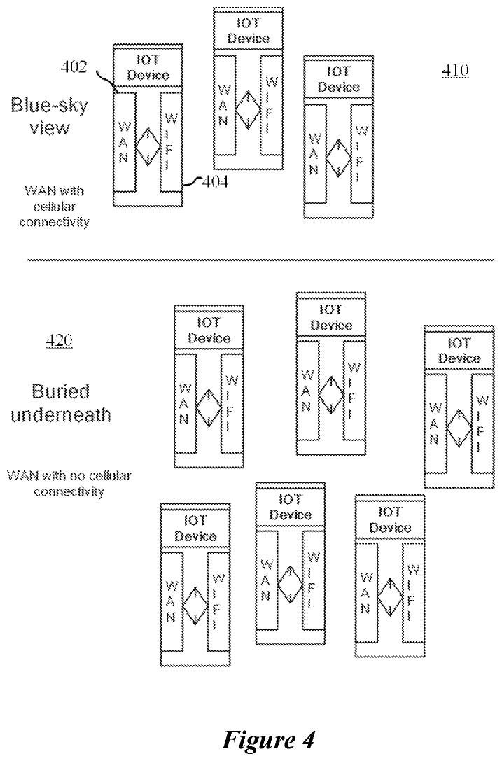

As noted above, devices may collaborate to provide multi-hop support so devices that do not have cellular coverage can still report their data. For example, as illustrated in FIG. 4, each tracking device may include both a WAN (cellular) interface 402 and a WLAN (WiFi) interface 404. As long as the devices are with range to communicate via WLAN, a first group of devices 410 with cellular connectivity may provide support to a second set of devices 420 that lack cellular connectivity (e.g., due to being buried beneath other containers).

Aspects of the present disclosure provide a framework using WLAN signaling to form an ad-hoc network cluster that allows devices to collaborate in a manner designed to ensure data connectivity for all devices. The signaling mechanisms provided herein may also improve positioning accuracy and battery life of the devices in the cluster. In some cases, an ad-hoc cluster may be formed and managed in a manner designed to optimize power consumption and help meet stringent batter life targets.

Techniques proposed herein enable ad-hoc network formation that may be a useful feature for advanced asset tracking. Using location awareness, the techniques may enable accurate tracking with low power consumption by blending WiFi and WAN signaling. Devices utilizing techniques described herein may be used in a variety of different types of applications in a variety of different industries (e.g., from devices tracking for shipping to tracking items on a manufacturing shop floor).

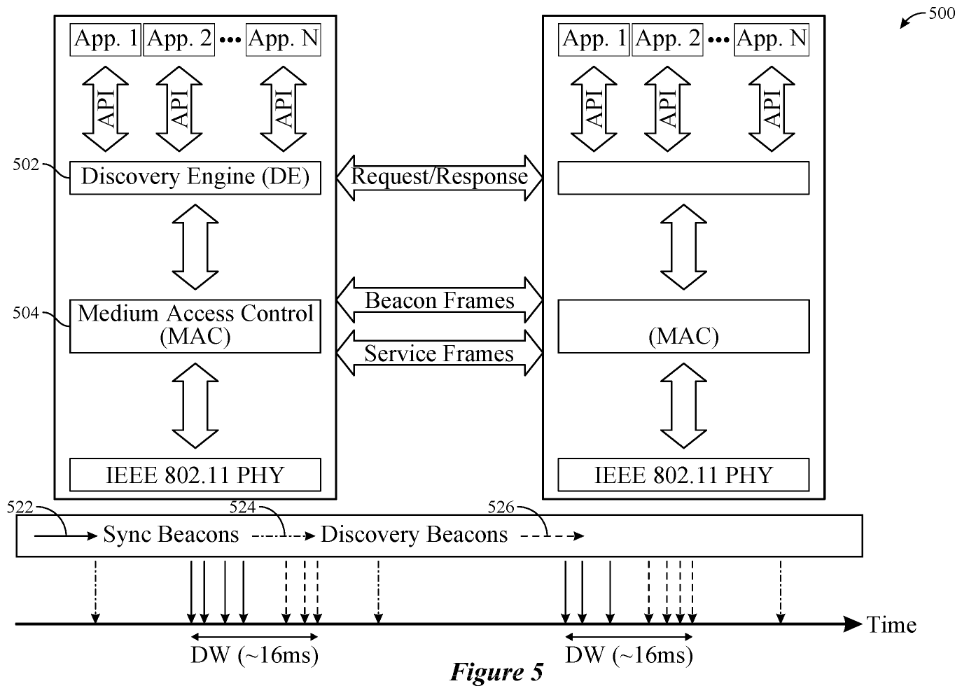

As illustrated in FIG. 5, NAN protocols rely upon the interaction of NAN devices 500 (two devices 500₁ and 500₂ are shown) grouped in a cluster 500. Clusters are automatically created by nearby NAN devices that cooperate to synchronize to a common Discovery Window (DW) schedule 528. During DWs, NAN devices participating in cluster maintenance/discovery are allowed to exchange service discovery frames 526 describing or requesting a service.

A NAN processing stack has various components, including a Discovery Engine (DE) 510 and a Medium Access Control (MAC) layer 520. The DE 510 generally provides basic Publish/Subscribe mechanisms to upper-layer services or applications (Apps. 1-N). The MAC is generally responsible for the maintenance of NAN clusters, such as creating, joining or merging clusters, preserving synchronization in the NAN cluster, and providing transmit and/or receive services to the DE.

Discovery beacons 524 may also be transmitted, allowing other devices to be able to detect a device or an existing cluster. Discovery beacons allow NAN devices to be able to discover existing NAN clusters with a minimal power consumption. NAN devices in a cluster synchronize their clocks in order to maintain their DWs aligned and to be able to exchange service discovery frames.

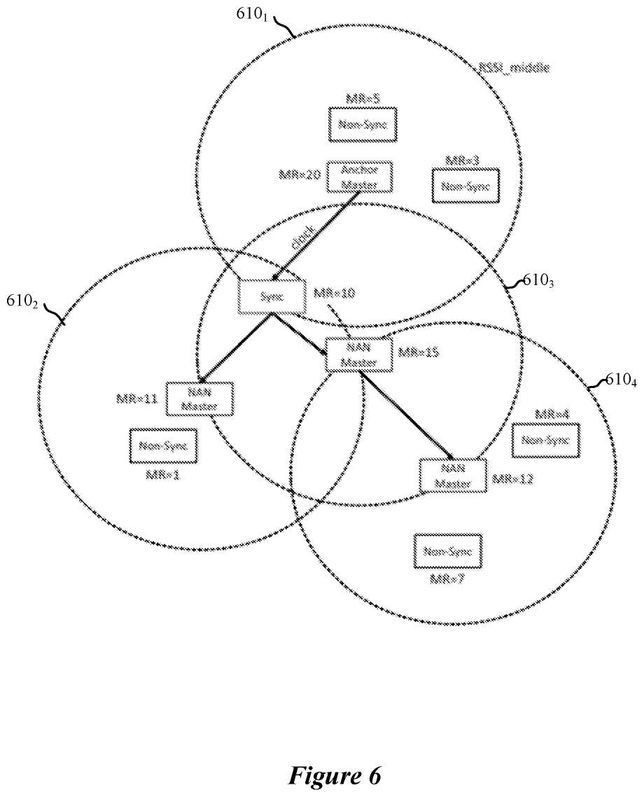

FIG. 6 illustrates various roles devices can perform in an example NAN network. An Anchor Master transmits Sync and Discovery, and Cluster timing. The example depicts four clusters 610₁ with an Anchor Master with a master rank (MR) of 20, 610₂ with a Master with an MR of 11, 610₃ with a Master with an MR of 10, and 6104 with a Master with a MR of 12. In such scenarios, a Master transmits Sync and Discovery beacons. A Non-Master Sync device transmits Sync beacons but not Discovery beacons, while Non-Master Non-Sync devices do not transmit Beacons.

One challenge in using NAN clusters for applications such as tracking is how to manage power for cluster discovery and maintenance. Aspects of the present disclosure provide may help address this challenge by allowing one or more parameters for cluster discovery and/or maintenance to be selected based on a particular use case. For example, for a tracking use case with stringent battery life targets, a relatively long interval between synchronized listen windows (DWs).

As another example, synchronization beacon pattern parameters (e.g., DW periodicity and interval between Sync beacons) may be selected that are designed to balance power and performance according to objectives (needs) of an application. In some cases, power may be (further) reduced by using an energy detector (with very low power) for detection of wake-up signal from nodes trying to establish connection.

These various mechanisms, individually or collectively, may reduce power consumption for cluster maintenance and for devices trying to discover a new cluster.

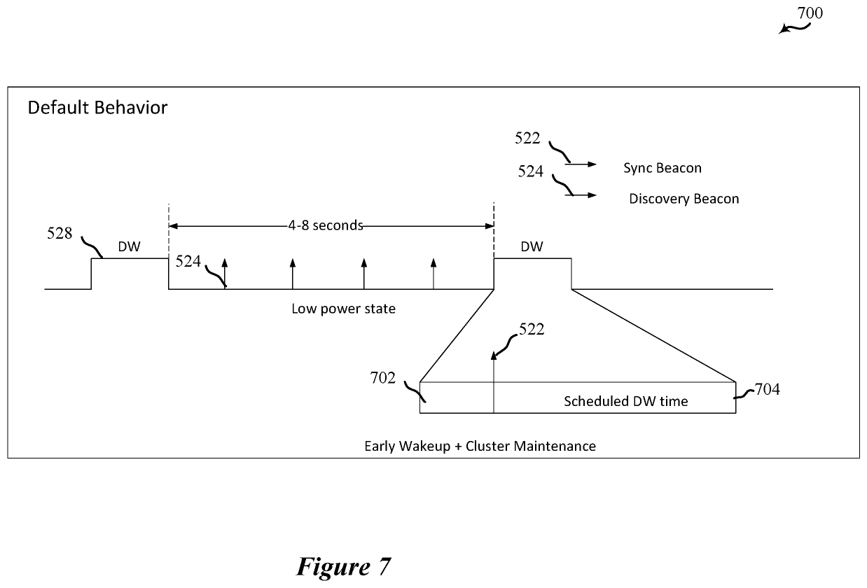

FIG. 7 illustrates an example that may help depict the potential challenge relating to power optimal cluster discovery and maintenance. As illustrated, a first portion of a DW may be used as an early wakeup period 702, allowing device hardware (e.g., clock oscillators) to settle. As noted above, some use cases have very sparse data (e.g., ˜200 Bytes once every 15-60 minutes or when an event occurs) and has very stringent battery requirements. Cluster maintenance cost in terms of power may be significant, with all the nodes waking up to listen during DWs 528.

Aspects of the present disclosure, however, propose adjusting parameters, such as the periodicity of common DWs, based on application objectives/requirements. In general, a long interval between DWs may result in lower power consumption for all nodes (as transmission and reception of sync beacons is less frequent). Devices in various roles (Anchor Master, Master, Non-Master Sync, and Non-Master Non-Sync) may need less frequent wakeups for beacon transmission or reception. However, longer DW periodicity may result in increased clock drift. This may depend on device clock resolution (e.g., crystal parts per million) with a longer early wakeup time. Longer cluster maintenance time may also result, as suitability of roles of devices may change (e.g., due to a change in WAN coverage or relative position of a device within cluster).

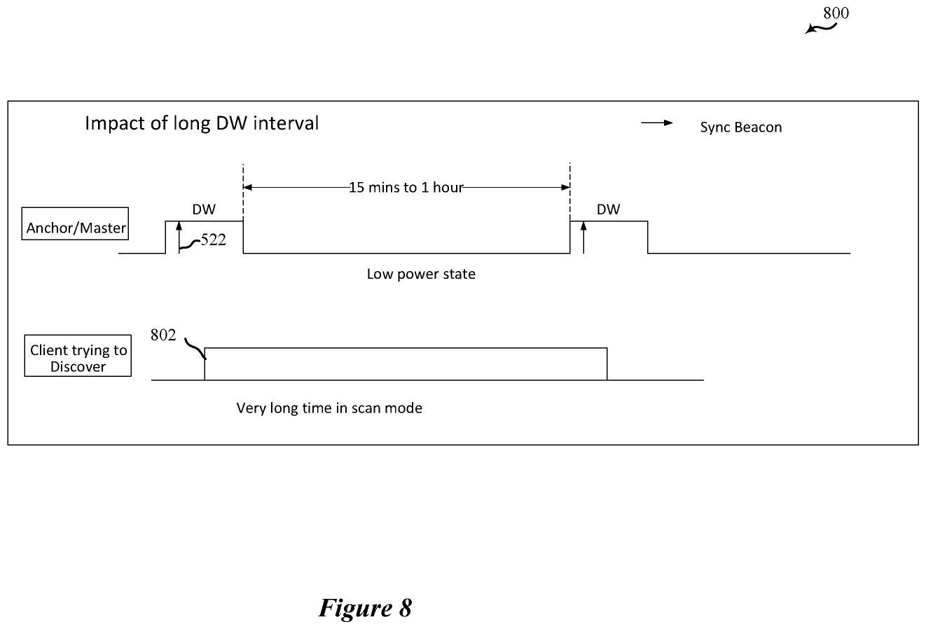

As illustrated at 802 of FIG. 8, if the interval between DWs is very large, any device trying to discover the cluster may spend a relatively long time in a listening mode. This may result in significant power consumption before the cluster is discovered.

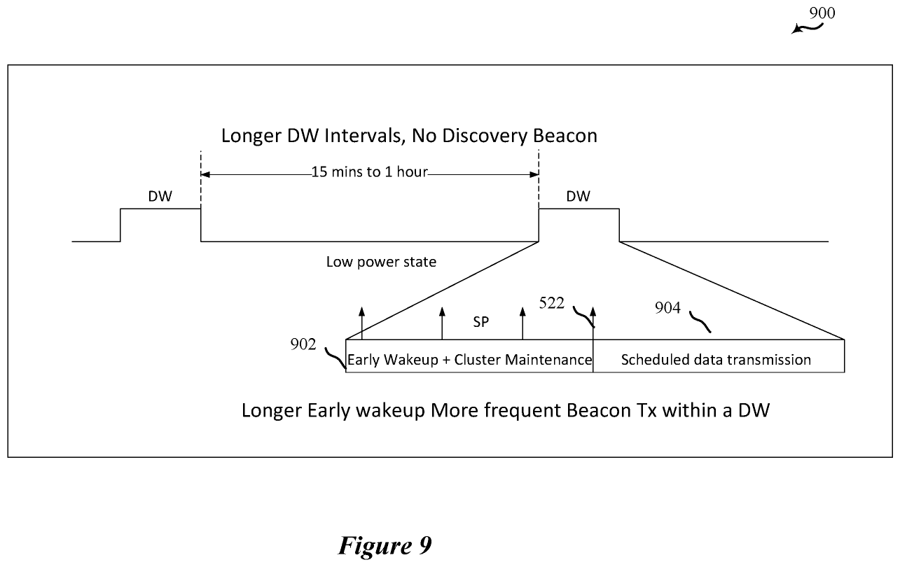

As illustrated in FIG. 9, aspects of the present disclosure may extend the interval between DWs and adjust the transmission pattern of sync beacons 522 during an early wakeup portion 902 of a DW period, which may result in reduced cluster discovery time. As illustrated in FIG. 9, the pattern may result in more frequent beacon transmissions within the early portion of the DW, prior to scheduled data transmission at 904.

In some cases, this adjusted synchronization (sync) beacon pattern may eliminate the need to transmit discovery beacons 524 between DWs, which may further save power. In other words, sync beacons 522 may be effectively used for cluster discovery.

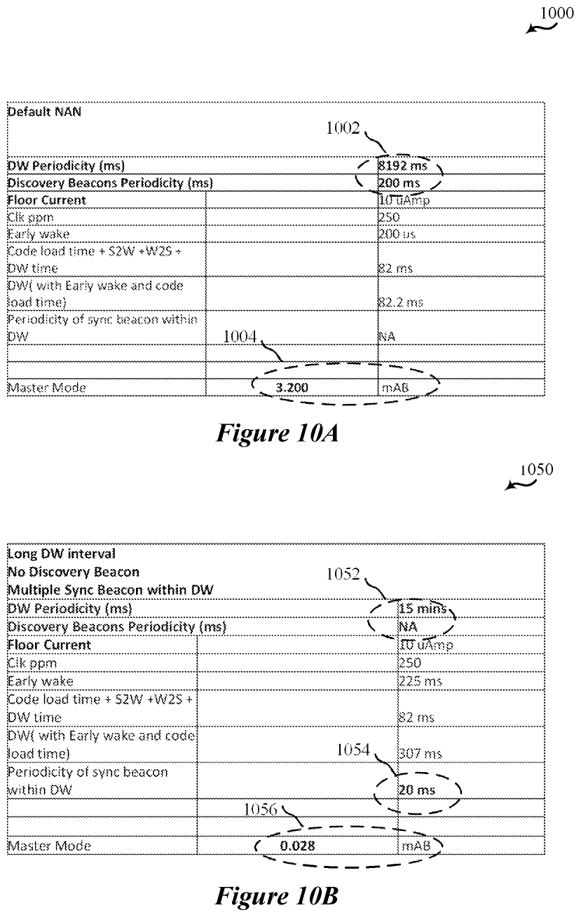

An example of the potential power savings can be seen by comparing the example power consumption listed in table 1000 of FIG. 10A, achievable with conventional discovery beacon transmission, to the power consumption listed in table 1050 of FIG. 10B, achieved with no discovery beacon transmissions. As shown, a conventional approach shown in FIG. 10A may have a DW periodicity of 8192 ms with a discovery beacon periodicity of 200 ms, as shown at 1002. In contrast, the enhanced approach shown in FIG. 10B uses a longer DW periodicity of 15 minutes with no discovery beacons, as shown at 1052, but with a periodicity of sync beacons in the DW of 20 ms, as shown at 1054. As a result, in the illustrated example, a significant reduction in power may be achieved using a longer DW interval and new sync pattern rather than discovery beacons (e.g., from 3.2 mAB to 0.028 mAB), as shown at 1056.

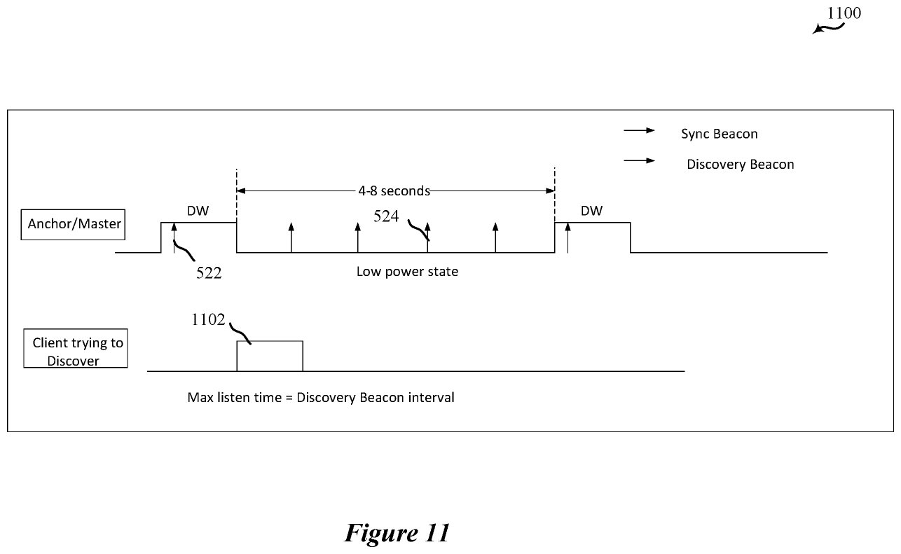

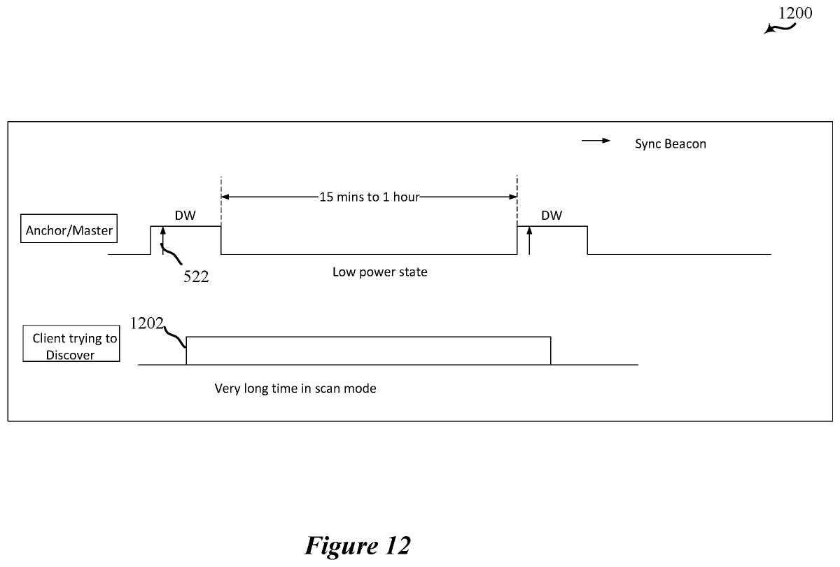

Aspects of the present disclosure may also help optimize cluster discovery power. As illustrated in FIG. 11, conventional behavior in a NAN protocol is for a client trying to discover to wake up and listen for a period 1102 selected to ensure that it spans a discovery beacon 524. As illustrated in FIG. 12, if a long DW interval is used with no discovery beacons between DWs, a client would have to stay awake for a correspondingly long time, as illustrated at 1202.

As described above, a device trying to discover a cluster may scan for discovery and/or sync beacons and the periodicity of discovery or sync beacon transmission will have an impact on discovery time and power. With no discovery beacons between DWs, anchor and master mode power may be reduced, but (as illustrated in FIG. 12) clients trying to discover the cluster may have to remain in the scan mode for very long time.

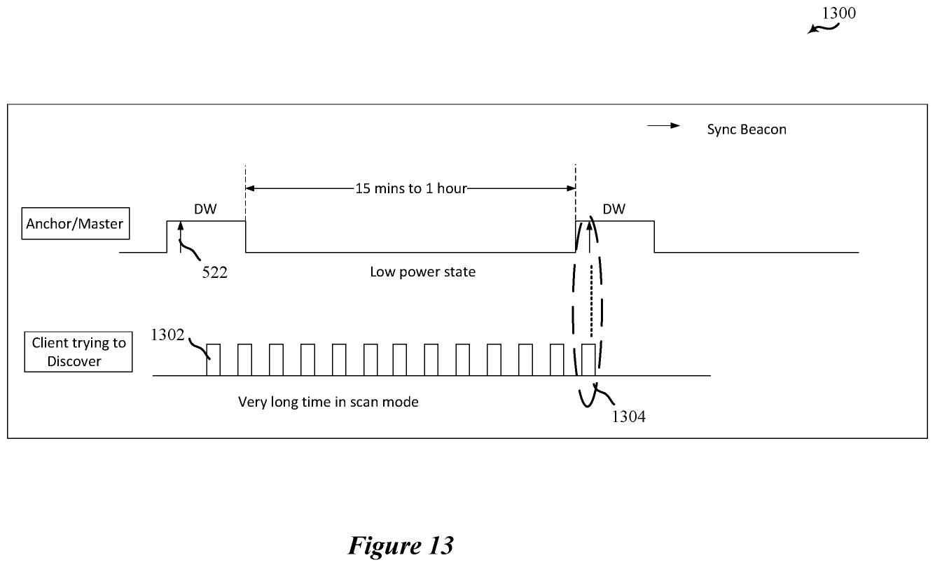

As depicted in FIG. 13, however, aspects of the present disclosure provide techniques enabling alternating (e.g., duty cycling) between listen ON modes 1302 and listen OFF modes. A periodicity and duty cycle (amount of On time) for the ON modes may be set in an effort to ensure discovery beacons are received, as shown at 1304.

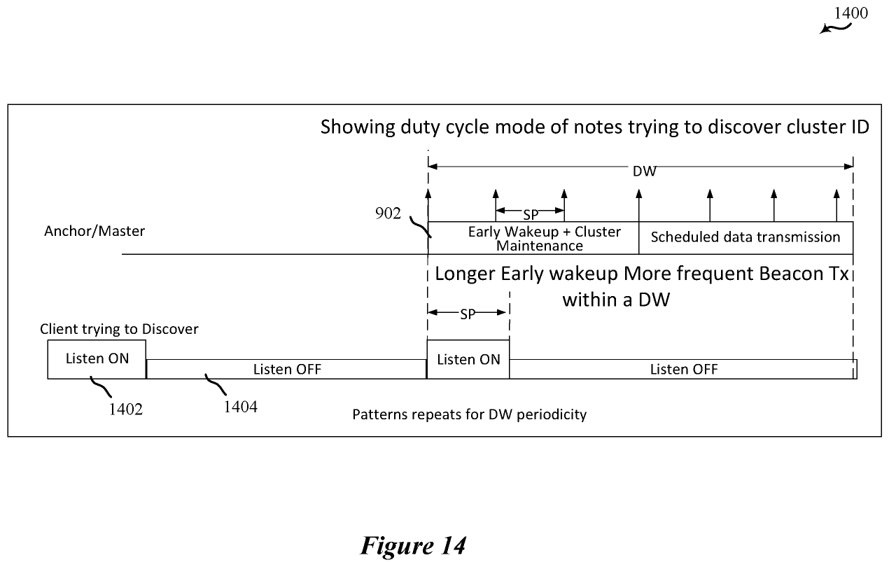

According to certain aspects, as illustrated in FIG. 14, if the sync beacon periodicity within a DW is designated as SP, then listening for SP duration once every DW period may ensure that when anchor master or master nodes wake up for DW and start transmitting sync beacons, the node trying to discover will be able to receive a beacon. The node trying to discover the cluster may still have to be in this mode for the DW interval, but the present approach may help reduce power consumption by duty cycling RF state (between Listen ON and Listen Off modes).

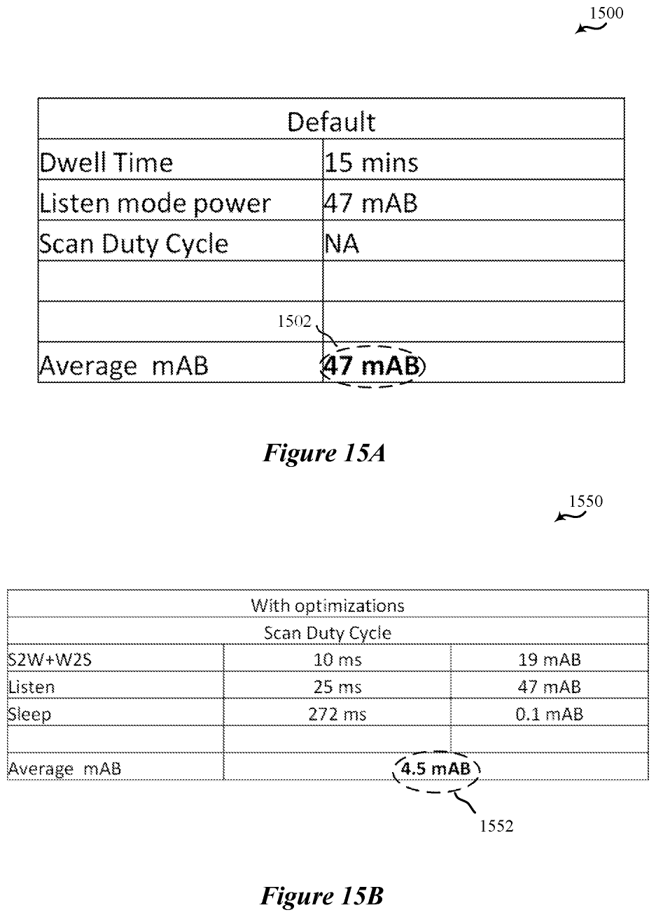

An example of the potential power savings that may be achieved with scan duty cycling, as shown in FIGS. 13 and 14, is demonstrated by comparing the example power consumption listed in table 1500 of FIG. 15A, achievable without scan duty cycling, to the power consumption listed in table 1550 of FIG. 15B, achieved with scan duty cycling. In the illustrated example, a significant reduction in power (e.g., a reduction of approximately 90%, from 47 mAB as shown at 1502 of FIG. 15A to 4.5 mAB as shown at 1552 of FIG. 15B) may be achieved by applying duty cycling to scanning.

Certain aspects of the present disclosure may help reduce power consumption by using a low power energy detector for cluster maintenance. Using a low power energy detector may allow a device to keep one or more processing components in a low power state longer than achievable during conventional listening modes.

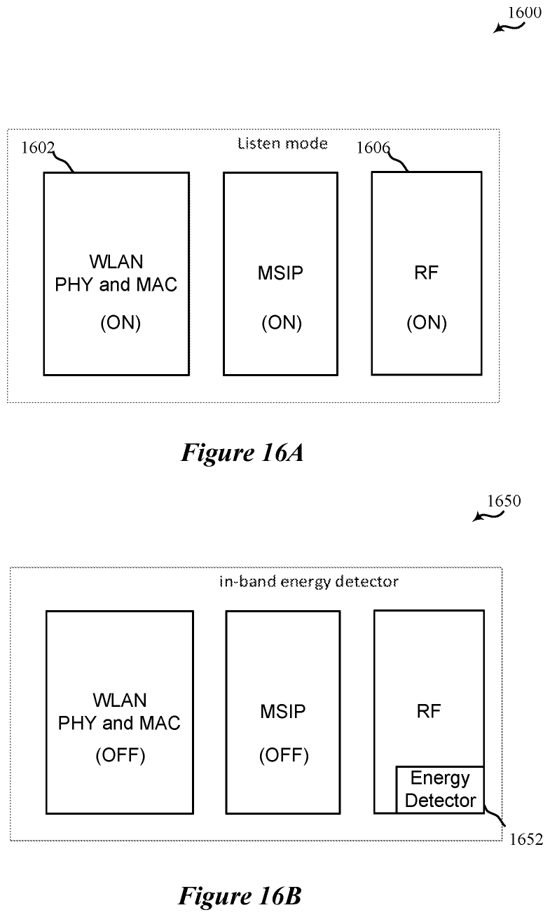

For example, as illustrated in FIG. 16A, during a conventional listening mode, a device may have several processing components powered up. For example, WLAN PHY and MAC layers 1602 may be powered on, as shown at 1602, as well as RF components 1606. Having these components powered on may result in substantial power consumption.

As illustrated in FIG. 16B, according to certain aspects, only a low power energy detector 1652 may be kept on, while other components may be powered off. This approach may use an energy detector module to reduce power consumption associated with session establishment. Utilizing wake up signals in conjunction with the low power detector may help achieve faster discovery and allow the triggering of impromptu sync beacons. In some cases, the energy detector may be enhanced to effectively achieve a WiFi energy detector (e.g., tuned to in-band WiFi signals), in order to reduce false detections.

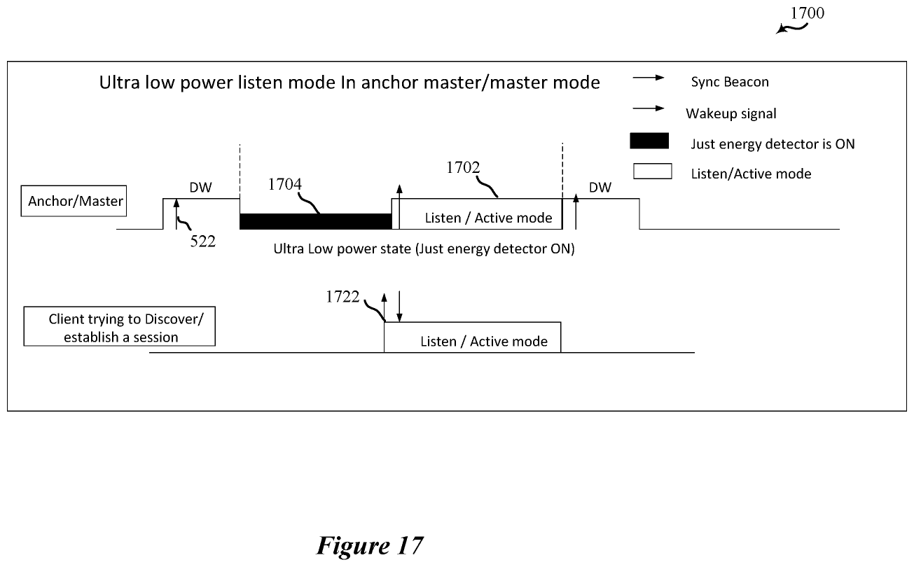

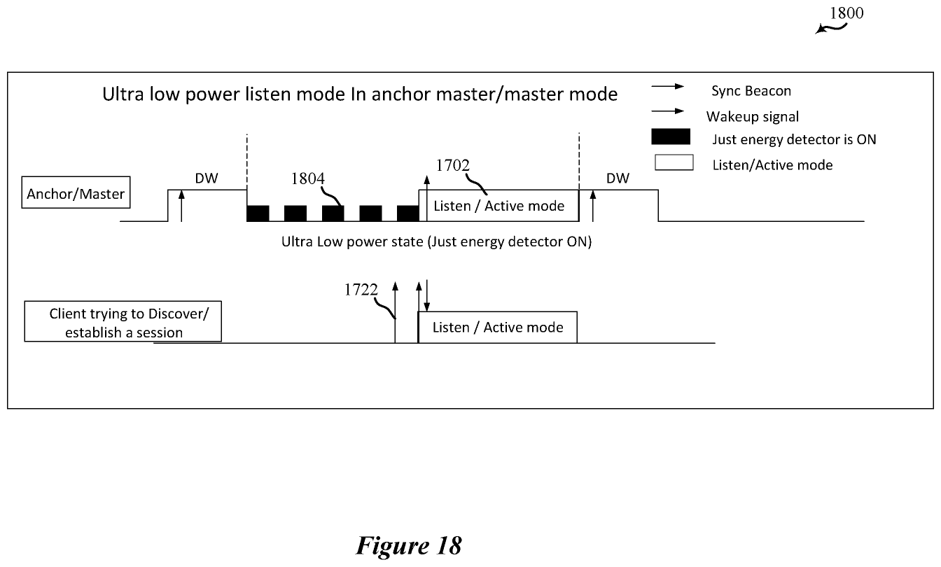

FIGS. 17 and 18 illustrate the anchor master/master mode device operating in this low power energy detector mode. As illustrated in FIG. 17, between DWs, a client (e.g., a tracker which has an event) may send out an energy signal 1722, which could be an industrial, scientific, and medical (ISM) band energy signal, or some other Wi-Fi (or other type) of signal. As illustrated, an anchor/master device is in energy detection mode 1704 between DWs. When the anchor/master detects the energy, it may power up other components (e.g., wake up the rest of the Wi-Fi stack/radio) and start sending sync beacons as the client listens. As illustrated, the anchor/master may also remain in the listen/active mode as indicated at 1702. As illustrated, the client trying to discover the cluster can then establish an impromptu DW window to exchange data.

In some cases, the choice of when to trigger the energy transmission may be based on whether the DW is close by or far away in time. The choice of listening to energy can be continuous or slotted. For example, as illustrated at 1804 of FIG. 18, listening may be performed with a certain duty cycle. In such cases, the transmitter may need to ensure it sends the signal for that window of time at least.

Another potential challenge in ad-hoc tracking network clusters relates to how to optimize data aggregation services and advertise the same during setup. This challenge may exist in various scenarios, such as when there is no available WLAN data connectivity to the cloud (e.g., outdoors), when some nodes have WAN connectivity, and/or when some nodes are in a WAN coverage hole.

Aspects of the present disclosure may help address this challenge by providing a framework for setting up an ad-hoc cluster with advertisement of data aggregator service, while providing for selection of the aggregator node. The aggregator node may be selected based on an advertised parameter referred to as an “aggregator rank” which may serve in a similar manner as a “master rank” used to select master and anchor master nodes in network cluster formation.

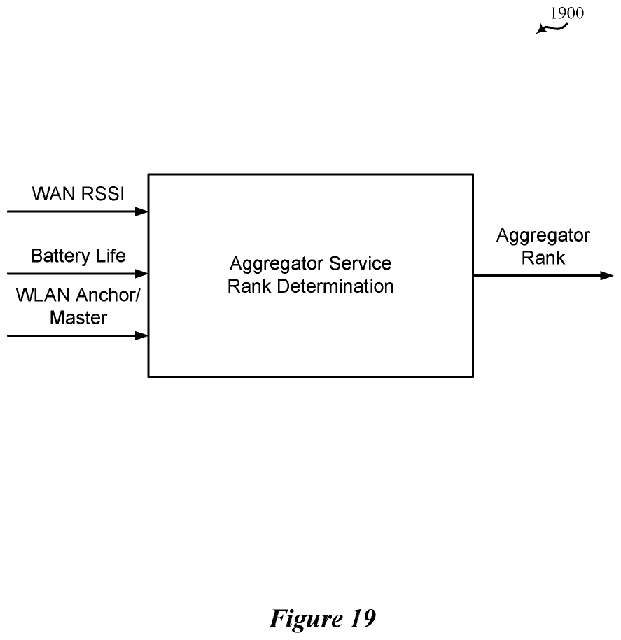

As illustrated in FIG. 19, in some cases, an aggregator rank may be determined as a function 1900 of various factors that impact suitability for serving as an aggregator node. Such factors may include, for example, WAN channel (e.g., receive signal strength indicator or RSSI) strength and remaining battery life. Further, WLAN anchor master/master nodes may have higher preference for serving as an aggregator node to avoid multiple hops of data packets.

In some cases, a device with the highest aggregator rank may be selected as Aggregator node. All WLAN devices, and possibly nodes with WAN coverage but not the aggregator node, may send data to the aggregator node.

The aggregator node may then report the data for all the devices to the network. As noted above, in this manner, role selection may be performed in a similar manner to other types of role selection mechanisms in NAN. It may be noted that it is not necessary to have devices with WAN coverage to be an anchor master/master.

In some cases, more than one aggregator node may be allowed to aggregate and report data to the network. This approach may help in load sharing for achieving higher battery life and reducing a number of hops.

Another potential challenge with using ad-hoc network clusters for applications such as tracking relates to optimizing collaboration of devices for positioning improvements. This challenge may be presented in various scenarios, such as when some of the nodes do not have WAN and GNSS coverage, and/or when GNSS and WAN positioning measurements are expensive in terms of power. The challenge may also be presented when an event occurs, for example, when a sensor connected to an IoT device senses a drop or high temperature and the device needs to report the location and time of the event, but the node does not have GNSS coverage.

Aspects of the present disclosure provide techniques that provide a framework for improved approximation of position. The improved approximation may be based on various factors, such as a cluster ID, relative position of nodes within the cluster, and tolerable location accuracy range of an application. In some case, improvements may be achieved using location data of other devices in the cluster measured over different time to extrapolate/interpolate the location of device reporting the event.

In some cases, approximation of location may be based on cluster ID and RSSI based relative position measurements and may account for the fact that different applications have different location accuracy requirements. For example, certain aspects provide techniques for formation of cluster sizes according to accuracy requirements of the application by reducing transmission power of sync beacons and allowed number of hops (master and sync nodes). In some aspects, instead of each node doing location measurements, the location of any device in the cluster may be shared to report position of the other nodes.

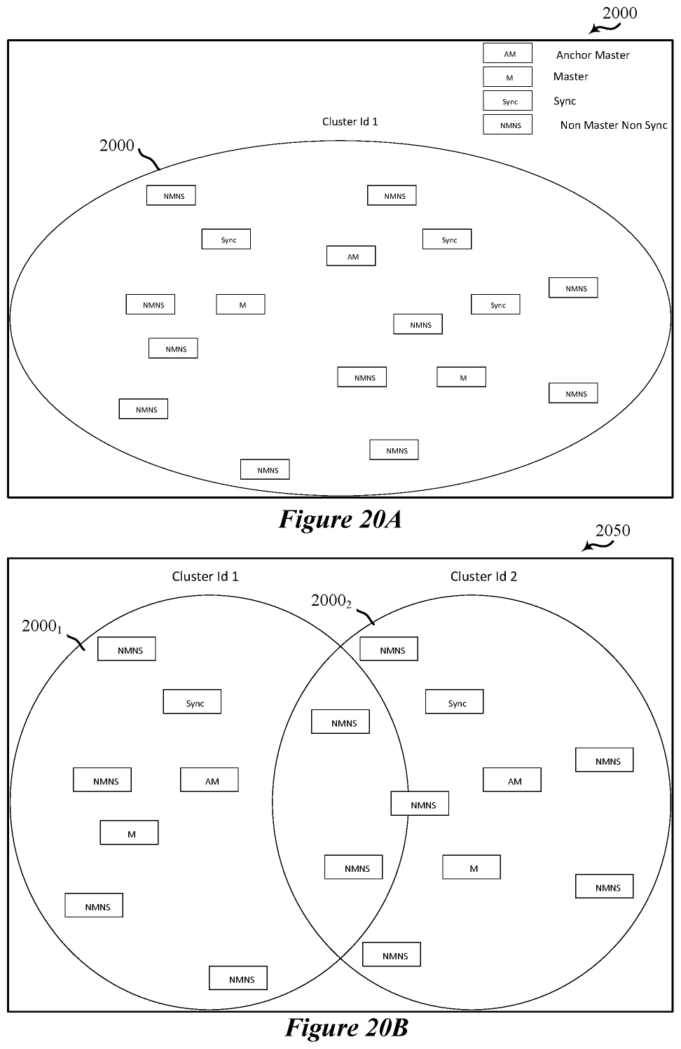

For example, this approach may be understood by considering a scenario where the accuracy requirement of the application is 100 meters. As shown in FIG. 20A, one large cluster 2000 cluster with a diameter up to 100 meters could be formed. As an alternative, instead of forming one cluster, multiple clusters 20001 and 20002 may be formed with a diameter of less than 50 meters. Using this approach, rather than being performed by all nodes in the cluster, the positioning method may be performed by a few nodes in the cluster. Position measurements of these different nodes may then be averaged and used for (e.g., all the) other nodes in the cluster.

The nodes that do report positions to the NW may report various information, such as a list of nodes in the cluster, positioning measurements (e.g., GNSS) for a subset of nodes (positioning method might be different for different nodes), and/or RSSI measurements from Beacon for relative positioning (e.g., free from cluster measurements, no additional power cost). In some cases, an aware cloud (application in the cloud) may extrapolate the location of all the nodes and use available positioning measurements of the few nodes in the cluster plus additional information, such as RSSI measurements for relative positioning, to extrapolate position for all the nodes.

These techniques may provide certain advantages including load balancing of positioning measurements across different nodes to reduce power consumptions, nodes without coverage for a positioning method (a device without GNSS coverage) benefits from measurements of other nodes, and smaller measurement reports.

In some cases, network cluster size may be controlled by limiting transmit power of the devices transmitting sync beacon(s) and/or by restricting a number of allowable hops.

According to certain aspects, a method of extrapolating location in the cloud for a particular time instant may be provided by using absolute and relative locations available across different devices in the clustered tagged with time of measurements.

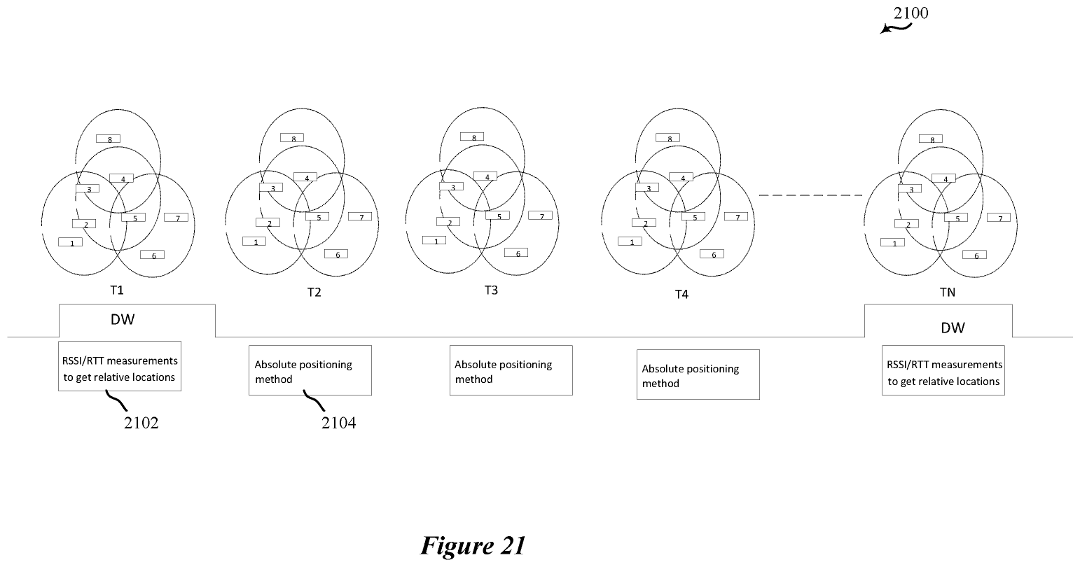

FIG. 21 illustrates an example of such an approach, which may be used to provide location and time tagging of events. For example, time tagging and geographical (geo) tagging of an event may be difficult for a node that may be in coverage hole of a reliable absolute positioning method.

As illustrated at 2102, measurement of relative locations in the cluster (e.g, based on RSSI and/or round trip times (RTTs) may be taken periodically (e.g., at times T1 and T5). As illustrated at 2104, sparse absolute position measurements may also be taken from different nodes in the cluster (e.g., from different nodes at different times).

All such measurements may be time tagged and reported, which may help improve location accuracy. For example, in some cases, the network may triangulate a location of each node by extrapolating time stamped locations and relative location of the nodes within the cluster.

Reporting position measurements in this manner may provide certain advantages. For example, distributing measurements in this manner may help with load sharing of (WAN, WLAN or GNSS) measurements for absolute position measurements. Further, by tagging and reporting measurements from different nodes with time stamps, along with WLAN RSSI measurements, the potential issue of large intervals between DWs may be mitigated.

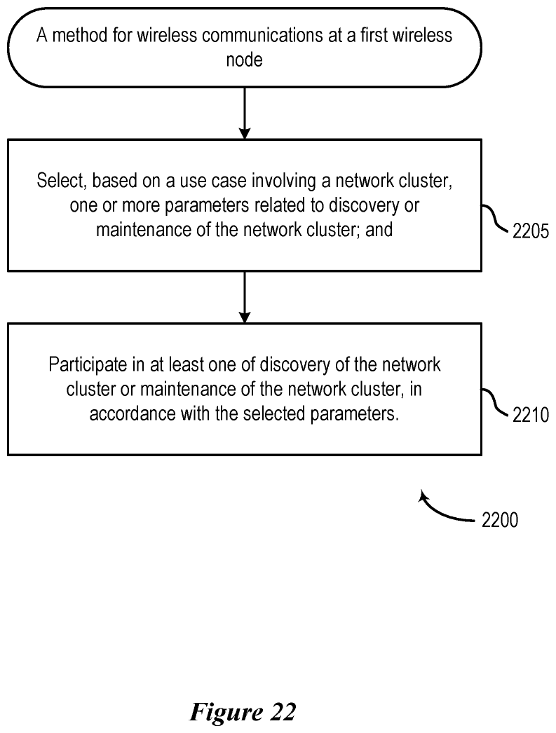

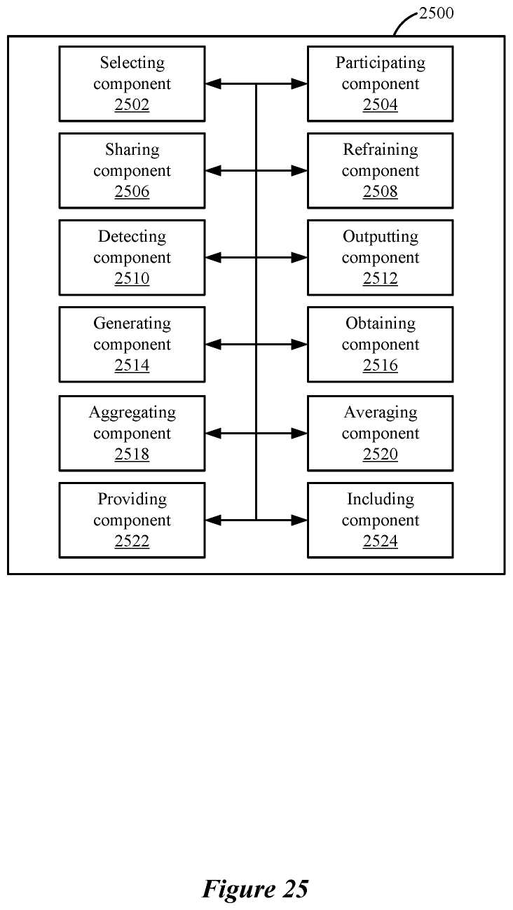

FIG. 22 shows a flowchart illustrating an example process 2200 performable at a wireless node, according to certain aspects of the present disclosure. The operations of the process 2200 may be implemented by a wireless AP or a STA, or its components as described herein. For example, the process 2200 may be performed by a wireless communication device, such as the wireless communication device 2500 described with reference to FIG. 25, operating as or within a wireless AP or STA. In some examples, the process 2200 may be performed by a wireless AP, such as one of the wireless APs 102 described with reference to FIG. 1. In some examples, the process 2200 may be performed by a STA, such as one of the STAs 104 described with reference to FIG. 1.

Process 2200 begins at step 2205 with selecting, based on a use case involving a network cluster, one or more parameters related to discovery or maintenance of the network cluster.

Process 2200 then proceeds to step 2210 with participating in at least one of discovery of the network cluster or maintenance of the network cluster, in accordance with the selected parameters.

In some aspects, the use case involves tracking a location of one or more wireless nodes in the network cluster.

In some aspects, the process 2200 further includes sharing location information of at least a second wireless node via a wireless wide area network (WWAN).

In some aspects, the one or more parameters comprise a duration of intervals between adjacent discovery windows (DWs); and the participating involves outputting, for transmission, one or more synchronization beacons in DWs separated by the intervals.

In some aspects, the intervals are on an order of minutes.

In some aspects, the one or more synchronization beacons are output for transmission in an early wakeup period of the DWs.

In some aspects, the process 2200 further includes refraining from transmitting discovery beacons in the intervals between DWs.

In some aspects, the one or more parameters further comprise a synchronization beacon pattern parameters; and the one or more synchronization beacons are output for transmission in DWs in accordance with the synchronization beacon pattern parameters.

In some aspects, the synchronization beacon pattern parameters comprise at least one of a DW periodicity or interval between synchronization beacons, selected based on the use case.

In some aspects, the process 2200 further includes detecting a wakeup signal from a second wireless node during an interval between DWs, while one or more processing blocks of the first wireless node are disabled.

In some aspects, the process 2200 further includes outputting, for transmission, at least one synchronization beacon between DWs after enabling the one or more processing blocks, after detecting the wakeup signal.

In some aspects, the detecting is performed when monitoring for the wakeup signal during intervals between DWs, according to a duty cycle.

In one aspect, process 2200, or any aspect related to it, may be performed by an apparatus, such as wireless communications device 2500 of FIG. 25, which includes various components operable, configured, or adapted to perform the process 2200. Wireless communications device 2500 is described below in further detail.

Note that FIG. 22 is just one example of a method, and other methods including fewer, additional, or alternative steps are possible consistent with this disclosure.

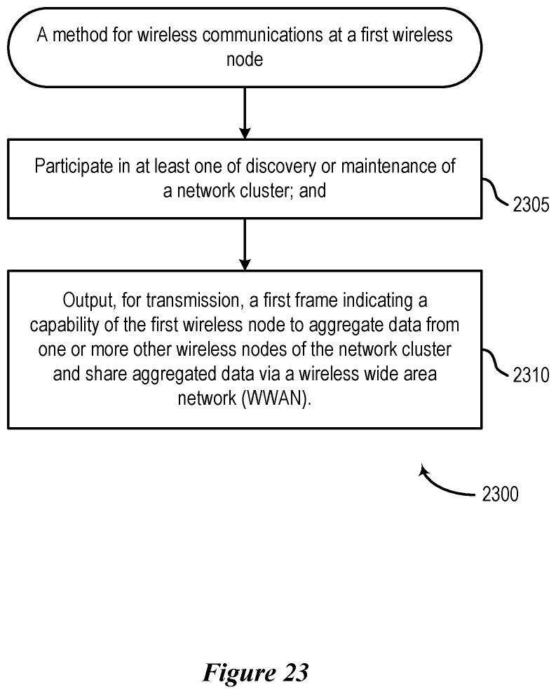

FIG. 23 shows a flowchart illustrating an example process 2300 performable at a wireless node, according to certain aspects of the present disclosure. The operations of the process 2300 may be implemented by a wireless AP or a STA, or its components as described herein. For example, the process 2300 may be performed by a wireless communication device, such as the wireless communication device 2500 described with reference to FIG. 25, operating as or within a wireless AP or STA. In some examples, the process 2300 may be performed by a wireless AP, such as one of the wireless APs 102 described with reference to FIG. 1. In some examples, the process 2300 may be performed by a STA, such as one of the STAs 104 described with reference to FIG. 1.

Process 2300 begins at step 2305 with participating in at least one of discovery or maintenance of a network cluster.

Process 2300 then proceeds to step 2310 with outputting, for transmission, a first frame indicating a capability of the first wireless node to aggregate data from one or more other wireless nodes of the network cluster and share aggregated data via a wireless wide area network (WWAN).

In some aspects, the first wireless node is one of multiple wireless nodes allowed to aggregate data and share aggregated data via the WWAN.

In some aspects, the first frame further indicates an aggregation rank.

In some aspects, the process 2300 further includes generating the aggregation rank as a function of at least one of: a signal quality metric for the WWAN measured by the first wireless node, a remaining battery life of the at least one wireless node, or a role performed by the first wireless node in the network cluster.

In some aspects, the process 2300 further includes obtaining a second frame indicating the first wireless node has been selected as an aggregator node.

In some aspects, the process 2300 further includes aggregating data obtained from at least one other wireless node with data of the first wireless node.

In some aspects, the process 2300 further includes outputting the aggregated data for transmission via the WWAN.

In one aspect, process 2300, or any aspect related to it, may be performed by an apparatus, such as wireless communications device 2500 of FIG. 25, which includes various components operable, configured, or adapted to perform the process 2300. Wireless communications device 2500 is described below in further detail.

Note that FIG. 23 is just one example of a method, and other methods including fewer, additional, or alternative steps are possible consistent with this disclosure.

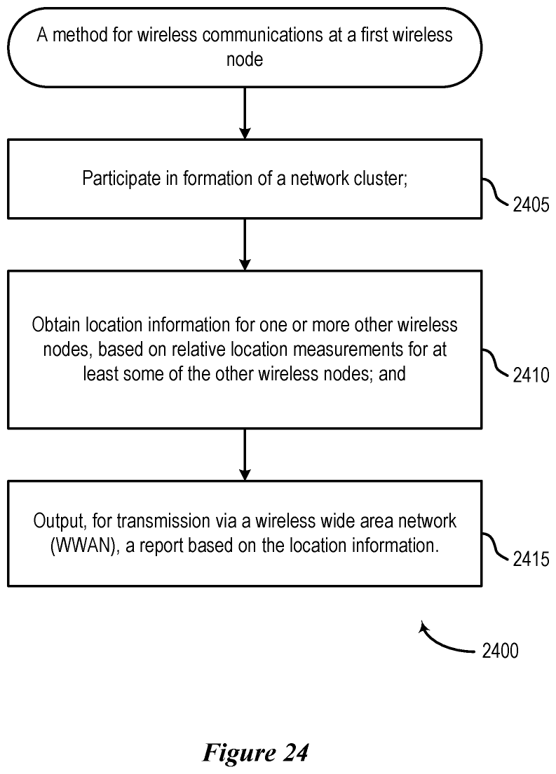

FIG. 24 shows a flowchart illustrating an example process 2400 performable at a wireless node, according to certain aspects of the present disclosure. The operations of the process 2400 may be implemented by a wireless AP or a STA, or its components as described herein. For example, the process 2400 may be performed by a wireless communication device, such as the wireless communication device 2500 described with reference to FIG. 25, operating as or within a wireless AP or STA. In some examples, the process 2400 may be performed by a wireless AP, such as one of the wireless APs 102 described with reference to FIG. 1. In some examples, the process 2400 may be performed by a STA, such as one of the STAs 104 described with reference to FIG. 1.

Process 2400 begins at step 2405 with participating in formation of a network cluster.

Process 2400 then proceeds to step 2410 with obtaining location information for one or more other wireless nodes, based on relative location measurements for at least some of the other wireless nodes.

Process 2400 then proceeds to step 2415 with outputting, for transmission via a wireless wide area network (WWAN), a report based on the location information.

In some aspects, participating in formation of a network cluster comprises outputting, for transmission, synchronization beacons with limited transmit power.

In some aspects, the location information is obtained from one or more other wireless nodes subject to a restricted number of hops.

In some aspects, a size of the network cluster is based on an accuracy objective of an application.

In some aspects, the location information is based on absolute location information associated with a first subset of the wireless nodes.

In some aspects, the process 2400 further includes averaging location information obtained from the first subset of the wireless nodes.

In some aspects, the process 2400 further includes providing, in the report, the average location information for all wireless nodes in the network cluster.

In some aspects, the process 2400 further includes including, in the report: absolute location information for the first subset of the wireless nodes of the network cluster, and relative location information for a second subset of the wireless nodes of the network cluster.

In some aspects, the process 2400 further includes including, in the report: information indicating timing associated with the absolute location information, and information indicating timing associated with the relative location information.

In one aspect, process 2400, or any aspect related to it, may be performed by an apparatus, such as wireless communications device 2500 of FIG. 25, which includes various components operable, configured, or adapted to perform the process 2400. Wireless communications device 2500 is described below in further detail.

Note that FIG. 24 is just one example of a method, and other methods including fewer, additional, or alternative steps are possible consistent with this disclosure.

FIG. 25 shows a block diagram of an example wireless communication device 2500, according to some aspects of the present disclosure. In one example, the wireless communication device 2500 is configured or operable to perform a process 2200, 2300, and/or 2400 described with reference to FIGS. 22, 23, and 24 respectively. In various examples, the wireless communication device 2500 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some examples, the wireless communication device 2500 can be a device for use in an AP, such as AP 102 described with reference to FIG. 1. In some examples, the wireless communication device 2500 can be a device for use in a STA, such as STA 104 described with reference to FIG. 1. In some other examples, the wireless communication device 2500 can be an AP or a STA that includes such a chip, SoC, chipset, package or device as well as multiple antennas. The wireless communication device 2500 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some examples, the wireless communication device 2500 also includes or can be coupled with an application processor which may be further coupled with another memory. In some examples, the wireless communication device 2500 further includes at least one external network interface that enables communication with a core network or backhaul network to gain access to external networks including the Internet.

The wireless communication device 2500 includes at least a selecting component 2502, a participating component 2504, a sharing component 2506, a refraining component 2508, a detecting component 2510, an outputting component 2512, a generating component 2514, an obtaining component 2516, an aggregating component 2518, an averaging component 2520, a providing component 2522, and an including component 2524. Portions of one or more of the components 2502, 2504, 2506, 2508, 2510, 2512, 2514, 2516, 2518, 2520, 2522, and/or 2524 may be implemented at least in part in hardware or firmware. For example, the obtaining component 2516 may be implemented at least in part by a modem. In some examples, at least some of the components 2502, 2504, 2506, 2508, 2510, 2512, 2514, 2516, 2518, 2520, 2522, and/or 2524 are implemented at least in part by a processor and as software stored in a memory. For example, portions of one or more of the components 2502, 2504, 2506, 2508, 2510, 2512, 2514, 2516, 2518, 2520, 2522, and/or 2524 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 2500). For example, a processing system of the wireless communication device 2500 may refer to a system including the various other components or subcomponents of the wireless communication device 2500, such as the processor, or a transceiver, or a communications manager, or other components or combinations of components of the wireless communication device 2500. The processing system of the wireless communication device 2500 may interface with other components of the wireless communication device 2500, and may process information received from other components (such as inputs or signals) or output information to other components. For example, a chip or modem of the wireless communication device 2500 may include a processing system, a first interface to output information and a second interface to obtain information. In some implementations, the first interface may refer to an interface between the processing system of the chip or modem and a transmitter, such that the wireless communication device 2500 may transmit information output from the chip or modem. In some implementations, the second interface may refer to an interface between the processing system of the chip or modem and a receiver, such that the wireless communication device 2500 may obtain information or signal inputs, and the information may be passed to the processing system. A person having ordinary skill in the art will readily recognize that the first interface also may obtain information or signal inputs, and the second interface also may output information or signal outputs.

### EXAMPLE CLAUSES

Implementation examples are described in the following numbered clauses:

Clause 1: A method for wireless communications at a first wireless node, comprising: selecting, based on a use case involving a network cluster, one or more parameters related to discovery or maintenance of the network cluster; and participating in at least one of discovery of the network cluster or maintenance of the network cluster, in accordance with the selected parameters.

Clause 2: The method of Clause 1, wherein: the use case involves tracking a location of one or more wireless nodes in the network cluster.

Clause 3: The method of any one of Clauses 1-2, further comprising sharing location information of at least a second wireless node via a wireless wide area network (WWAN).

Clause 4: The method of any one of Clauses 1-3, wherein: the one or more parameters comprise a duration of intervals between adjacent discovery windows (DWs); and the participating involves outputting, for transmission, one or more synchronization beacons in DWs separated by the intervals.

Clause 5: The method of Clause 4, wherein the intervals are on an order of minutes.

Clause 6: The method of Clause 4, wherein the one or more synchronization beacons are output for transmission in an early wakeup period of the DWs.

Clause 7: The method of Clause 4, further comprising refraining from transmitting discovery beacons in the intervals between DWs.

Clause 8: The method of Clause 4, wherein: the one or more parameters further comprise a synchronization beacon pattern parameters; and the one or more synchronization beacons are output for transmission in DWs in accordance with the synchronization beacon pattern parameters.

Clause 9: The method of Clause 8, wherein the synchronization beacon pattern parameters comprise at least one of a DW periodicity or interval between synchronization beacons, selected based on the use case.

Clause 10: The method of Clause 8, further comprising: detecting a wakeup signal from a second wireless node during an interval between DWs, while one or more processing blocks of the first wireless node are disabled; and outputting, for transmission, at least one synchronization beacon between DWs after enabling the one or more processing blocks, after detecting the wakeup signal.

Clause 11: The method of Clause 10, wherein the detecting is performed when monitoring for the wakeup signal during intervals between DWs, according to a duty cycle.

Clause 12: A method for wireless communications at a first wireless node, comprising: participating in at least one of discovery or maintenance of a network cluster; and outputting, for transmission, a first frame indicating a capability of the first wireless node to aggregate data from one or more other wireless nodes of the network cluster and share aggregated data via a wireless wide area network (WWAN).

Clause 13: The method of Clause 12, wherein the first wireless node is one of multiple wireless nodes allowed to aggregate data and share aggregated data via the WWAN.

Clause 14: The method of any one of Clauses 12-13, wherein the first frame further indicates an aggregation rank.

Clause 15: The method of Clause 14, further comprising generating the aggregation rank as a function of at least one of: a signal quality metric for the WWAN measured by the first wireless node, a remaining battery life of the at least one wireless node, or a role performed by the first wireless node in the network cluster.

Clause 16: The method of any one of Clauses 12-15, further comprising: obtaining a second frame indicating the first wireless node has been selected as an aggregator node; aggregating data obtained from at least one other wireless node with data of the first wireless node; and outputting the aggregated data for transmission via the WWAN.

Clause 17: A method for wireless communications at a first wireless node, comprising: participating in formation of a network cluster; obtaining location information for one or more other wireless nodes, based on relative location measurements for at least some of the other wireless nodes; and outputting, for transmission via a wireless wide area network (WWAN), a report based on the location information.

Clause 18: The method of Clause 17, wherein participating in formation of a network cluster comprises outputting, for transmission, synchronization beacons with limited transmit power.

Clause 19: The method of any one of Clauses 17-18, wherein the location information is obtained from one or more other wireless nodes subject to a restricted number of hops.

Clause 20: The method of any one of Clauses 17-19, wherein a size of the network cluster is based on an accuracy objective of an application.

Clause 21: The method of Clause 20, wherein the location information is based on absolute location information associated with a first subset of the wireless nodes.

Clause 22: The method of Clause 21, further comprising: averaging location information obtained from the first subset of the wireless nodes; and providing, in the report, the average location information for all wireless nodes in the network cluster.

Clause 23: The method of Clause 21, further comprising including, in the report: absolute location information for the first subset of the wireless nodes of the network cluster, and relative location information for a second subset of the wireless nodes of the network cluster.

Clause 24: The method of Clause 23, further comprising including, in the report: information indicating timing associated with the absolute location information, and information indicating timing associated with the relative location information.

Clause 25: An apparatus, comprising: a memory comprising executable instructions; and a processor configured to execute the executable instructions and cause the apparatus to perform a method in accordance with any one of Clauses 1-24.

Clause 26: An apparatus, comprising means for performing a method in accordance with any one of Clauses 1-24.

Clause 27: A non-transitory computer-readable medium comprising executable instructions that, when executed by at least one processor of a wireless node, cause the apparatus to perform a method in accordance with any one of Clauses 1-24.

Clause 28: A computer program product embodied on a computer-readable storage medium comprising code for performing a method in accordance with any one of Clauses 1-24.

Clause 29: A wireless node, comprising: at least one transceiver; a memory comprising executable instructions; and at least one processor configured to execute the executable instructions and cause the wireless node to perform a method in accordance with any one of Clauses 1-11, wherein the at least one transceiver is used when participating in at least one of discovery of the network cluster or maintenance of the network cluster, in accordance with the selected parameters.

Clause 30: A wireless node, comprising: at least one transceiver; a memory comprising executable instructions; and at least one processor configured to execute the executable instructions and cause the wireless node to perform a method in accordance with any one of Clauses 12-16, wherein the at least one transceiver is configured to transmit the first frame.

Clause 31: A wireless node, comprising: at least one transceiver; a memory comprising executable instructions; and at least one processor configured to execute the executable instructions and cause the wireless node to perform a method in accordance with any one of Clauses 17-24, wherein the at least one transceiver is configured to receive the location information and transmit the report.

### ADDITIONAL CONSIDERATIONS

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

Means for selecting, means for participating, means for sharing, means for refraining, means for detecting, means for outputting, means for generating, means for obtaining, means for aggregating, means for averaging, means for providing, and means for including may comprise one or more processors, such as one or more of the processors described above with reference to FIG. 25.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
at least one memory comprising computer-executable instructions; and
one or more processors configured to execute the computer-executable instructions and cause the apparatus to:
select, at a first wireless node based on a use case involving a network cluster, one or more parameters related to discovery or maintenance of the network cluster; and
participate in at least one of discovery of the network cluster or maintenance of the network cluster, in accordance with the selected parameters.

2. The apparatus of claim 1, wherein:
the use case involves tracking a location of one or more wireless nodes in the network cluster.

3. The apparatus of claim 1, wherein the one or more processors are further configured to cause the apparatus to: share location information of at least a second wireless node via a wireless wide area network (WWAN).

4. The apparatus of claim 1, wherein:
the one or more parameters comprise a duration of intervals between adjacent discovery windows (DWs); and
in order to participate, the one or more processors are further configured to cause the apparatus to output, for transmission, one or more synchronization beacons in DWs separated by the intervals.

5. The apparatus of claim 4, wherein the intervals are on an order of minutes.

6. The apparatus of claim 4, wherein the one or more synchronization beacons are output for transmission in an early wakeup period of the DWs.

7. The apparatus of claim 4, wherein the one or more processors are further configured to cause the apparatus to: refrain from transmitting discovery beacons in the intervals between DWs.

8. The apparatus of claim 4, wherein:
the one or more parameters further comprise synchronization beacon pattern parameters; and
the one or more synchronization beacons are output for transmission in DWs in accordance with the synchronization beacon pattern parameters.

9. The apparatus of claim 8, wherein the synchronization beacon pattern parameters comprise at least one of a DW periodicity or interval between synchronization beacons, selected based on the use case.

10. The apparatus of claim 8, wherein the one or more processors are further configured to cause the apparatus to:
detect a wakeup signal from a second wireless node during an interval between DWs, while one or more processing blocks of the first wireless node are disabled; and
output, for transmission, at least one synchronization beacon between DWs after enabling the one or more processing blocks, after detecting the wakeup signal.

11. The apparatus of claim 10, wherein the detecting is performed when monitoring for the wakeup signal during intervals between DWs, according to a duty cycle.

12. The apparatus of claim 1, wherein the one or more processors are further configured to cause the apparatus to:
output, for transmission, a first frame indicating a capability of the first wireless node to aggregate data from one or more other wireless nodes of the network cluster and share aggregated data via a wireless wide area network (WWAN).

13. The apparatus of claim 12, wherein the first wireless node is one of multiple wireless nodes allowed to aggregate data and share aggregated data via the WWAN.

14. The apparatus of claim 12, wherein the first frame further indicates an aggregation rank.

15. The apparatus of claim 14, wherein the one or more processors are further configured to cause the apparatus to: generate the aggregation rank as a function of at least one of: a signal quality metric for the WWAN measured by the first wireless node, a remaining battery life of the at least one wireless node, or a role performed by the first wireless node in the network cluster.

16. The apparatus of claim 12, wherein the one or more processors are further configured to cause the apparatus to:
obtain a second frame indicating the first wireless node has been selected as an aggregator node;
aggregate data obtained from at least one other wireless node with data of the first wireless node; and
output the aggregated data for transmission via the WWAN.

17. A method for wireless communications at a first wireless node, comprising:
selecting, based on a use case involving a network cluster, one or more parameters related to discovery or maintenance of the network cluster; and
participating in at least one of discovery of the network cluster or maintenance of the network cluster, in accordance with the selected parameters.

18. The method of claim 17, wherein:
the use case involves tracking a location of one or more wireless nodes in the network cluster.

19. The method of claim 17, further comprising:
outputting, for transmission, a first frame indicating a capability of the first wireless node to aggregate data from one or more other wireless nodes of the network cluster and share aggregated data via a wireless wide area network (WWAN).

20. A first wireless node, comprising:
at least one transceiver;
at least one memory comprising computer-executable instructions; and
one or more processors configured to execute the computer-executable instructions and cause the first wireless node to:
select, based on a use case involving a network cluster, one or more parameters related to discovery or maintenance of the network cluster; and
participate in at least one of discovery of the network cluster or maintenance of the network cluster using the at least one transceiver, in accordance with the selected parameters.
